(19) United States
(12) Patent Application Publication
(10) Pub. No.: US 2024/0251748 A1
(43) Pub. Date: Aug. 1, 2024

(54) POTTY TRAINING DEVICE

(71) Applicant: Myeong Jin HWANG, Seoul (KR)

(72) Inventor: Myeong Jin HWANG, Seoul (KR)

(21) Appl. No.: 18/418,406

(22) Filed: Jan. 22, 2024

(30) Foreign Application Priority Data
Jan. 30, 2023 (KR) 10-2023-0011590

(51) Int. Cl. A01K 1/01

(52) U.S. Cl. CPC A01K 1/0121

(57) ABSTRACT

A potty training device includes: a support member providing a support surface for supporting a pet, wherein at least a portion of the support surface is capable of receiving defecation inducers; and an interfering member disposed on the support member to hinder the pet from defecating in the defecation inducers. The support member includes: a support plate providing the support surface; and a discharge hole formed through the support plate so that the pet's excrement is discharged through the discharge hole. The interfering member is provided in a cover, wall, or grate shape and positioned above the defecation inducer, such that the pet is able to access the defecation inducer by smell, touch, or sight, but unable to defecate into the defecation inducer, and the interfering member.

### TECHNICAL FIELD

The present disclosure relates to a potty training device for training a pet to defecate.

### BACKGROUND

With the rise of single-person households and the booming pet industry, more and more households are raising dogs, cats, and various other pets, and one of the biggest challenges in pet care is excrement disposal.

Cats have a natural tendency to seek out sand or gravel to defecate, even without specific training. However, there are problems with sand management, such as getting sand on cats' paws and transferring the sand to other locations in the house, creating dust, and making the sand smell bad.

There is special sand on the market to address the above problems, but due to the grooming habits of cats, the sand dust on their paws may be absorbed into their bodies.

In addition, flushable litter boxes have been developed to address the problems due to sand use. This relates to a training method that simply places a sand plate on top of the litter box or gradually reduces the size of the sand plate, but cats are not easily trained by the above method.

### PRIOR ART DOCUMENT

### Patent Document

(Patent Document 1) Korean Patent Application Publication No. 10-2018-0136178 (Published on Dec. 24, 2018)

### SUMMARY

In view of the above, the present disclosure provides a potty training device for encouraging pets to defecate through a human toilet.

In accordance with a first embodiment of the present disclosure, there is provided a potty training device including: a support member providing a support surface for supporting a pet, wherein at least a portion of the support surface is configured to receive defecation inducers; and an interfering member disposed on the support member to hinder the pet from defecating in the defecation inducers,

Further, in the potty training device, the support member further may include a containment boundary portion projecting from the support surface to provide a containment space on the support surface in which the defecation inducers are received.

Further, in the potty training device, the interfering member is disposed toward the pet on the support member so that an end thereof is positioned above the excrement.

In accordance with a second embodiment of the present disclosure, there is provided a potty training device including: a support member providing a support surface for supporting a pet, wherein at least a portion of the support surface is configured to receive defecation inducers; and an interfering member disposed on the support member to hinder the pet from defecating in the defecation inducers, and disposed toward the pet on the support member so that an end thereof is positioned above the defecation inducers, wherein the support member includes: a support plate providing the support surface; a discharge hole formed through the support surface so that excrement of the pet is discharged through the discharge hole; and a guiderod extending from one end of the discharge hole toward the other end, and wherein an upper surface of the guide rod is configured to receive the defecation inducers. According to embodiments of the present disclosure, it is possible to encourage a pet to defecate through a human toilet using plentiful defecation inducers that pets like.

### BRIEF DESCRIPTION OF THE DRAWINGS

FIG. 1 is a side view showing a potty training device according to a first embodiment of the present disclosure received in a toilet.

FIG. 2 is a plan view showing the potty training device according to the first embodiment of the present disclosure.

FIG. 3 is a state view showing the potty training device according to the first embodiment of the present disclosure, wherein a pet is approaching the potty training device.

FIG. 4 is a state view showing the potty training device according to the first embodiment of the present disclosure, wherein a pet is defecating in the potty training device.

FIG. 5 is a side view showing the potty training device according to the first embodiment of the present disclosure with an interfering member in the form of a box.

FIG. 6 is a side view showing the potty training device according to the first embodiment of the present disclosure with an interfering member in the form of a grate.

FIG. 7 is a side view showing a potty training device according to a second embodiment of the present disclosure received on a toilet.

FIG. 8 is a plan view showing a potty training device according to a second embodiment of the present disclosure.

FIG. 9 is a state view showing the potty training device according to the second embodiment of the present disclosure, wherein a pet is defecating in the potty training device.

FIG. 10 is a state view showing the potty training device according to the second embodiment of the present disclosure with an interfering member added.

### DETAILED DESCRIPTION

Hereinafter, specific embodiments for implementing a spirit of the present disclosure will be described in detail with reference to the drawings.

In addition, in the description of the present disclosure, if it is determined that a detailed description of a related known configuration or function may obscure the gist of the present disclosure, the detailed description thereof will be omitted.

Further, when a component is referred to as being ‘connected’ to, ‘supported’ by, or ‘contacted’ with another component, it should be understood that the component may be directly connected to, supported by, or contacted with the other component, but that other component may exist therebetween.

Further, the terms used in the present disclosure are only used for describing the specific embodiments, and are not intended to limit the present disclosure. Singular expressions include plural expressions unless the context clearly indicates otherwise.

Further, in the present disclosure, it is to be noted that expressions, such as upper, lower, and side, are described based on the orientations shown in the drawings, but may be differently expressed if orientations of corresponding objects are changed. For the same reasons, some components are exaggerated, omitted, or schematically illustrated in the accompanying drawings, and the size of each component does not fully reflect the actual size.

Further, terms including ordinal numbers, such as first, second, etc., may be used for describing various components, but the corresponding components are not limited by these terms. These terms are only used for the purpose of distinguishing one component from another.

In the present specification, it is to be understood that the terms such as “including” are intended to indicate the existence of the certain features, areas, integers, steps, actions, elements, components, and/or groups thereof disclosed in the specification, and are not intended to preclude the possibility that one or more other features, areas, integers, steps, actions, elements, components, and/or groups thereof may exist or may be added.

Hereinafter, a potty training device according to embodiments of the present disclosure will be described.

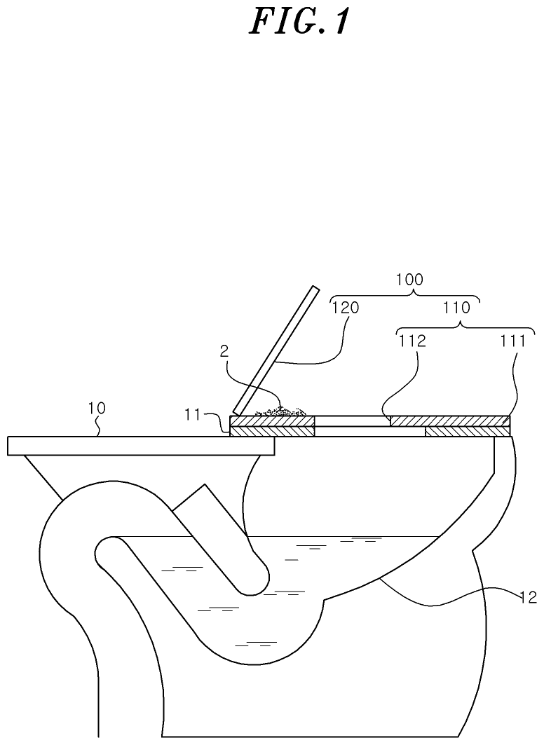

Referring to FIG. 1, a potty training device 100 according to a first embodiment of the present disclosure may induce a pet 1 to defecate through a toilet. At least a portion of the potty training device 100 may be supported on the toilet. In the present embodiment, the toilet may be provided in a conventional toilet shape, and may include a body 10 with an opening, a seat plate 11 placed at the opening for seating, and an excrement receptacle 12 that accommodates water to receive feces.

The potty training device 100 may selectively receive defecation inducers 2 for the pet 1. In this embodiment, the pet 1 may be, but is not limited to, a cat, for example, and may be considered any animal that can live with humans. The defecation inducers 2 may include a substance for inducing defecation of the pet 1. For example, the defecation inducers 2 may be at least one of sand and gravel, but not limited thereto. The defecation inducers 2 may be various types of substances that can induce defecation of the pet 1.

According to one embodiment of the present disclosure, the potty training device 100 may be a ready-to-use defecation positioning device that requires no training. Although the pet 1 is induced by the defecation inducers 2 of the potty training device 100 to defecate in the defecation inducers 2, the pet 1 is unable to defecate in the defecation inducers 2 due to the physical obstruction of an interfering member 120 and instead defecates through a discharge hole 112 proximate to the defecation inducers 2. Accordingly, the defecation inducers 2 are not contaminated by excrement, and the uncontaminated defecation inducers 2 can be used again, so that there is no need for cleaning due to excrement. Further, the defecation inducers 2 do not require functions of anti-dust, anti-odor, anti-secondary pollution, fast drying, good cohesion, etc.

According to another embodiment of the present disclosure, the potty training device 100 may enable potty training for the pet 1 to use a human toilet. In the early stage of potty training for the pet 1, the potty training device 100 may receive the defecation inducers 2, but in the case of the final stage of potty training of the pet 1, the potty training device 100 may receive a very small amount of defecation inducers 2, or no defecation inducers 2. When the defecation inducers 2 received in the potty training device 100 are removed little by little, the stress experienced by the pet 1 regarding defecating may be reduced in the absence of the defecation inducers 2. In the final training stage, the pet 1 may defecate in a human toilet without the potty training device 100. The reason why potty training is possible according to the second embodiment may be because a guide rod 114 of the interfering member 120 is in a position which makes it difficult for the pet 1 to take a defecation posture, or the guide rod 114 has a shape that can allow excrement of the pet 1 to easily slide into the discharge hole 112 without receiving the excrement.

Hereinafter, a potty training device formed by various embodiments of the present disclosure will be described in detail.

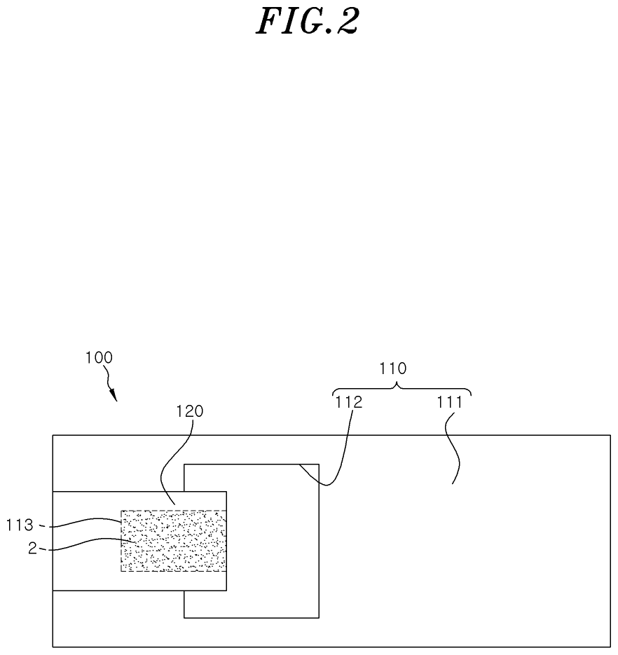

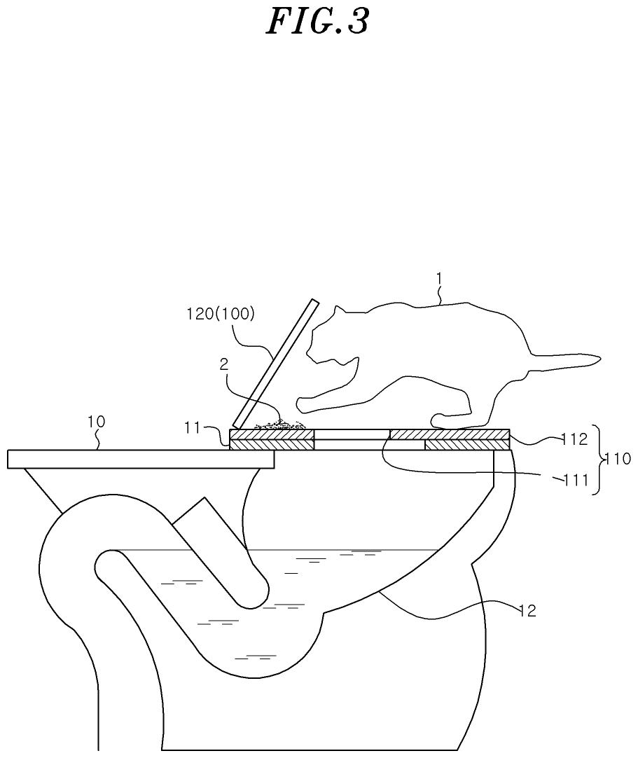

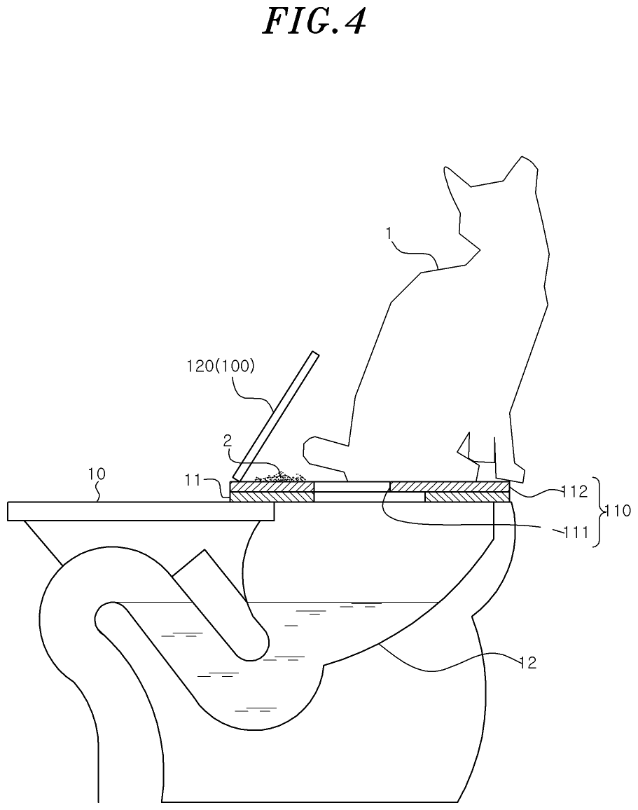

Referring to FIGS. 1 to 6, the potty training device 100 according to the first embodiment of the present disclosure may include a support member 110 and an interfering member 120. The support member 110 may be provided in the shape of a plate that can be mounted on the seat plate 11 of the body 10. The support member 110 may cover at least a portion of the opening of the body 10 on the upper side of the seat plate 11.

The support member 110 may include a support plate 111, a discharge hole 112, and a containment boundary portion 113. The support plate 111 may have a rectangular plate shape. As a matter of course, the present disclosure is not limited thereto, and the support plate 111 may be formed in any of various shapes capable of supporting the pet 1 for defection. For example, the support member 110 may have a circular plate shape or a shape corresponding to that of the seat plate 11.

The discharge hole 112 communicating with the opening of the body 10 may be formed in one end portion of the support plate 111. The containment boundary portion 113 may be formed between one end of the support plate 111 and the discharge hole 112. A support surface on which the defecation inducers 2 can be received may be formed on an upper surface of one end portion of the support plate 111. A support surface for the pet 1 to step on may be formed on an upper surface of the other end portion of the support plate 111.

The discharge hole 112 may be a passage through which excrement of the pet 1 can be discharged when the pet 1 defecates. The discharge hole 112 may be a square-shaped hole formed through one end portion of the support plate 111. The discharge hole 112 may communicate with the opening of the body 10. In the present embodiment, the discharge hole 112 is a square-shaped hole, but the discharge hole 112 may also be formed in a shape that minimizes the excrement getting stuck on the edge of the discharge hole 112. For example, the discharge hole 112 may be an oval-shaped or circular-shaped hole.

The containment boundary portion 113 may provide a containment space in which the defecation inducers 2 can be received on the support surface of the support plate 111. The containment boundary portion 113 may be a rim structure upwardly protruding from the support surface with the defecation inducers 2 received therein to prevent the defecation inducers 2 from escaping. The defecation inducers 2 received in the containment boundary portion 113 may induce defecation of the pet 1. During the defecation of the pet 1, excrement from the pet 1 may pass through the discharge hole 112 and fall into the excrement receptacle 12 of the toilet. In the present embodiment, the containment boundary portion 113 is a structure that protrudes from the support surface of the support plate 111, but may be formed in any of various shapes that prevent the defecation inducers 2 from escaping. For example, the containment boundary portion 113 may be provided in a groove shape recessed from the support surface.

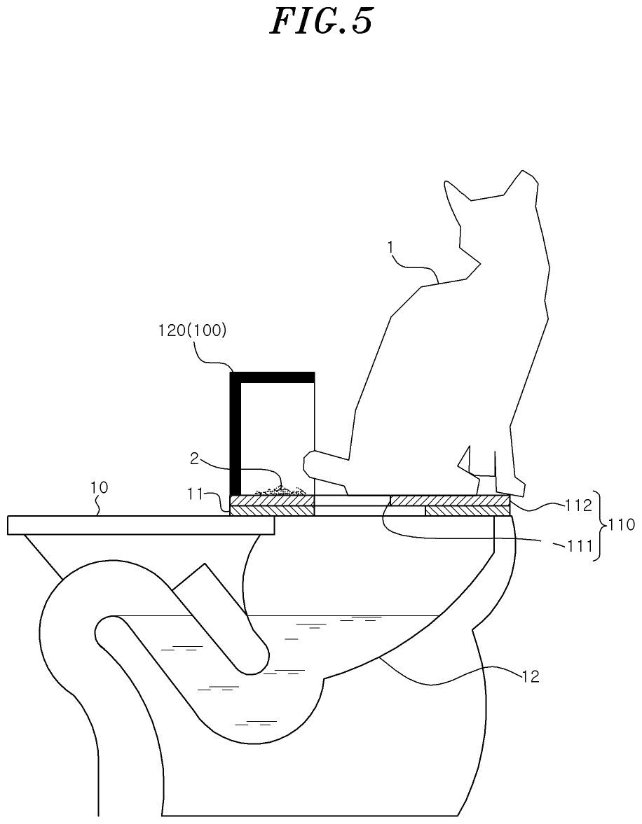

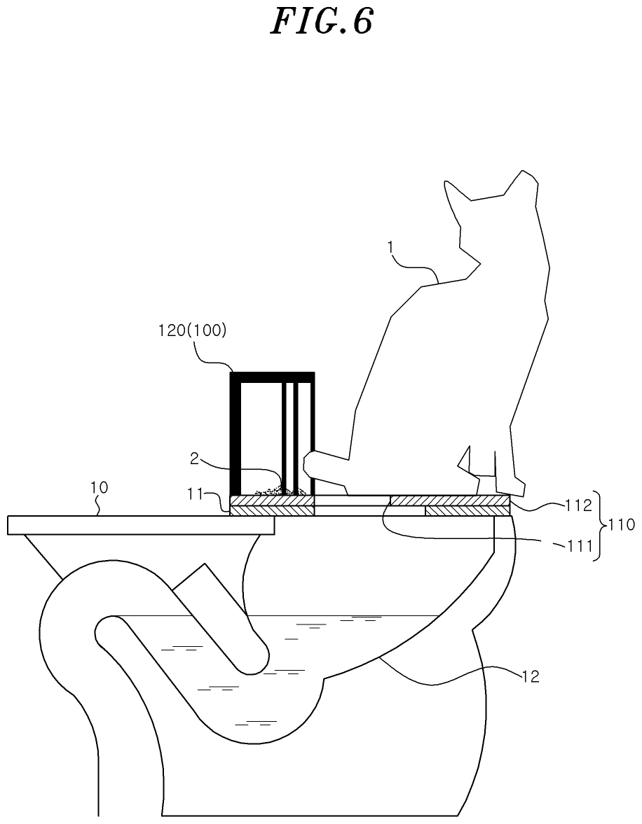

The interfering member 120 may interfere with the pet 1 defecating in the defecation inducers 2. The interfering member 120 is disposed on the support member 110 in which the defecation inducers 2 are received, thereby preventing the buttocks of the pet 1 from being positioned above the defecation inducers 2. The interfering member 120 is disposed at an inclined angle toward the pet 1 at one end of the support member 110, so that an end of the interfering member 120 can be positioned above the defecation inducers 2. The interfering member 120 may be provided in any of various forms that can prevent the buttocks of the pet 1 from being positioned above the defecation inducers 2 while allowing the pet 1 to contact the defecation inducers 2 through its paws or the like. For example, the interfering member 120 may be an inclined plane. In addition, referring to FIG. 5, the interfering member 120 may have a box shape such as a hexahedron or a dome. Furthermore, referring to FIG. 6, the interfering member 120 may be in the form of an opening or a grate so that the paws of the pet 1 can contact the defecation inducers 2.

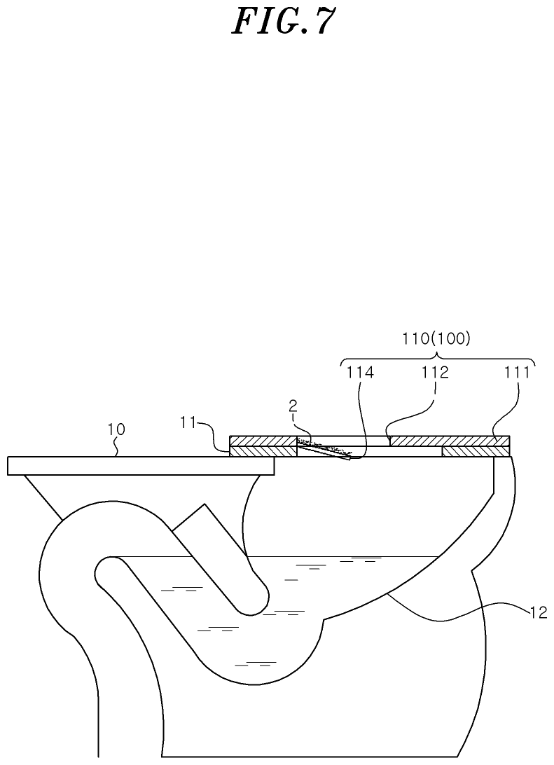

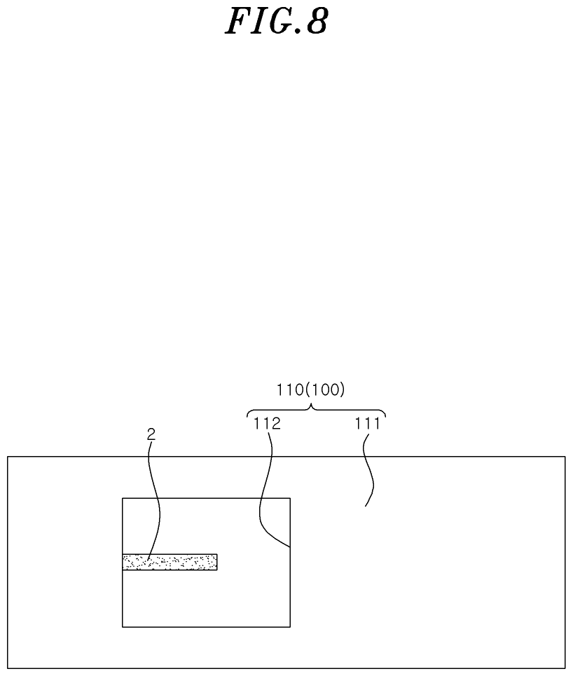

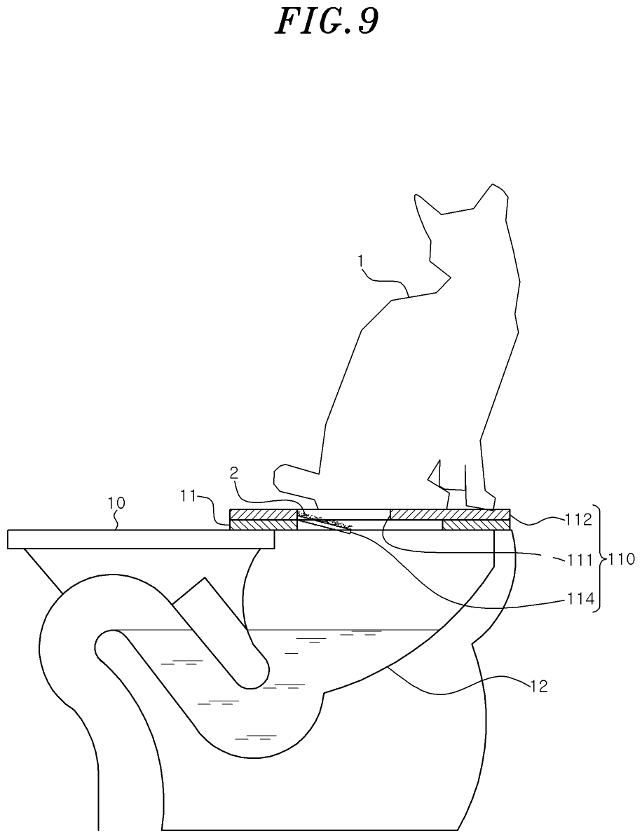

Referring to FIGS. 7 to 9, a potty training device 100 according to a second embodiment of the present disclosure may induce a pet 1 to defecate through a toilet without a separate interfering member 120. The second embodiment differs from the first embodiment described above in that the potty training device 100 is capable of inducing the defecation of the pet 1 in a toilet without the interfering member 120, and thus, the following description will focus on the differences of the second embodiment from the first embodiment, and like reference numerals will be given to like components and redundant description thereof will be omitted. This potty training device 100 may include a support member 110 that provides a guide rod 114.

The support member 110 may be provided in the shape of a plate that can be mounted on the seat plate 11 of the body 10. The support member 110 may cover at least a portion of the opening of the body 10 on the upper side of the seat plate 11. The support member 110 may include a support plate 111, a discharge hole 112, and a guide rod 114.

The support plate 111 may have a rectangular plate shape. The discharge hole 112 communicating with the opening of the body 10 may be formed in one end portion of the support plate 111. A support surface for the pet 1 to step on may be formed on an upper surface of the other end portion of the support plate 111.

The discharge hole 112 may be a passage through which excrement of the pet 1 can be discharged when the pet 1 defecates. The discharge hole 112 may be a square-shaped hole formed through one end portion of the support plate 111. The discharge hole 112 may communicate with the opening of the body 10. In the present embodiment, the discharge hole 112 is a square-shaped hole, but the discharge hole 112 may also be formed in a shape that minimizes the excrement getting stuck on the discharge hole 112. For example, the discharge hole 112 may be an oval-shaped or circular-shaped hole.

The guide rod 114 may be formed to extend in one direction from the discharge hole 112. For example, the guide rod 114 may have a rod shape extending from one end of the discharge hole 112 toward the other end. The defecation inducers 2 may be received on an upper surface of the guide rod 114. The defecation inducers 2 received in the guide rod 114 may induce defecation of the pet 1. During the defecation of the pet 1, excrement from the pet 1 may pass through the discharge hole 112 and fall into the excrement receptacle 12 of the toilet.

Depending on the shape of the discharge hole 112, the guide rod 114 may be disposed at a location where the pet 1 can access with its paws or the like, but where it is difficult for the pet 1 to make a defecation posture above the defecation inducers 2.

Depending on the size, shape, or material of the guide rod 114, the guide rod 114 may have difficulty accommodating the excrement of the pet 1 and may be prone to shedding the excrement into the discharge hole 112. For example, the guide rod 114 may have a narrow and long shape.

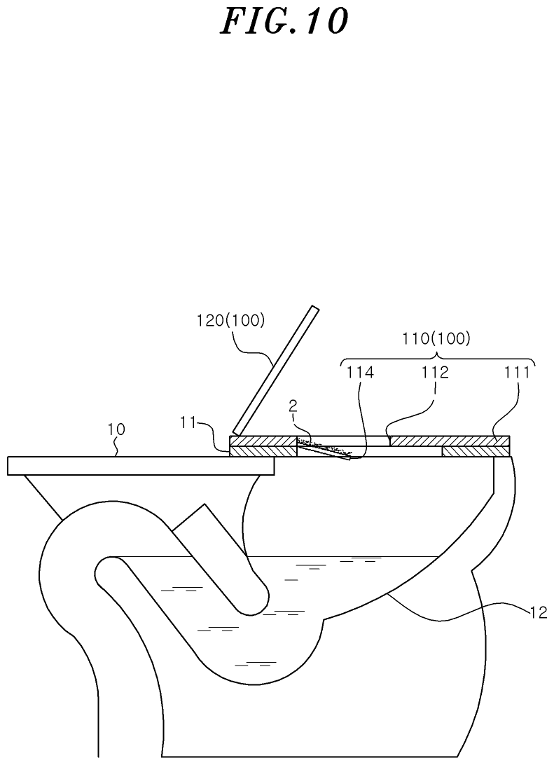

Referring to FIG. 10, the potty training device 100 according to the second embodiment of the present disclosure may further include an interfering member 120. Since the configuration of the interfering member 120 is the same as that of the interfering member 120 in the first embodiment, a description thereof will be omitted.

Hereinafter, a potty training method using the potty training device according to the embodiment of the present disclosure will be described.

In the potty training method using the potty training device 100 according to one embodiment of the present disclosure, in a state in which the potty training device 100 is mounted on a body 10 of a toilet, defecation inducers 2 are received in the potty training device 100. The defecation inducers 2 are needed to induce a pet 1 to defecate. Thus, as the defecation inducers 2 received in a containment member are provided at the body 10, the pet 1 may be guided to the potty training device 100 for defecation by smell and touch and attempt to defecate on the defecation inducers 2. However, the buttocks of the pet 1 cannot be positioned above the defecation inducers 2, the pet 1 may defecate in the discharge hole 112, which is close to the defecation inducers 2 and allows for an easy defecation posture. As the defecation inducers 2 include plentiful sand and gravel, which the pet 1 likes, the pet 1 may feel the satisfaction of using the potty training device 100.

According to another embodiment of the present disclosure, the potty training device 100 can enable potty training for the pet 1 to use a human toilet. In the early stage of potty training for the pet 1, the potty training device 100 may receive the defecation inducers 2, but in the case of the final stage of potty training for the pet 1, the potty training device 100 may receive a very small amount of defecation inducers 2, or no defecation inducers 2. When the defecation inducers 2 received in the potty training device 100 are removed little by little or when the defecation inducers 2 are not present, the pet 1 may experience less stress over the act of defecation. In the final training stage, the pet 1 may defecate in a human toilet without the potty training device 100. In other embodiments, potty training may be possible because the guide rod 114 is at a position which makes it difficult for the pet 1 to take a defecation posture, or because the guide rod 114 has a shape that can allow the excrements of the pet 1 to easily slide into the discharge hole 112 without receiving the excrements.

In the potty training method using the potty training device 100 according to the embodiment of the present disclosure, in a state in which the potty training device 100 is mounted on the body 10 of a toilet, and the defecation inducers 2 are received in the potty training device 100. The defecation inducers 2 are needed to induce the pet 1 to defecate. Accordingly, as the defecation inducers 2 received in a containment member are provided at the body 10, the pet 1 may be guided to the potty training device 100 for defecation by smell and touch. As the defecation inducers 2 include plentiful sand and gravel, which the pet 1 likes, the pet 1 may feel the satisfaction of using the potty training device 100.

In the first embodiment of the present disclosure, after the pet 1 is guided to the potty training device 100, the pet 1 attempts to defecate in the defecation inducers 2, but because the buttocks of the pet 1 cannot be positioned above the defecation inducers 2 due to the interfering member 120, the pet 1 defecates in the discharge hole 112, which is close to the defecation inducers 2 and allows for an easy defecation posture.

In one example of the second embodiment of the present disclosure, after the pet 1 is guided to the potty training device 100, the pet 1 attempts to defecate in the defecation inducers 2, but because the pet 1 is unable to make a posture so that the buttocks of the pet 1 are positioned above the defecation inducers 2 due to the position of the defecation inducers 2 and the shape and width of the discharge hole 112, the pet 1 defecates in the discharge hole 112, which is closer to the defecation inducers 2 and allows for an easy defecation posture.

In another example of the second embodiment of the present disclosure, after the pet 1 is guided to the potty training device 100, the pet 1 attempts to defecate in the defecation inducers 2, but even when the pet 1 defecates in the defecation inducers 2, the excrement may flow down into the discharge hole 112 naturally during a defecation process or during a cleanup process of the pet 1 due to the shape and width of the guide rod 114.

Meanwhile, if the pet 1 performs the act of defecation smoothly through the potty training device 100 while the defecation inducers 2 of the pet 1 is received in the potty training device 100, the defecation inducers 2 received in the toilet training device 100 may be gradually removed over a predetermined period of time. It is preferable to check whether the pet 1 is smoothly defecating through the potty training device 100 after the defecation inducers 2 received in the potty training device 100 is gradually removed over the predetermined amount.

If the pet 1 is smoothly defecating through the potty training device 100 even while the defecation inducers 2 received in the potty training device 100 are gradually removed over the predetermined amount, the defecation inducers 2 received in the potty training device 100 may be completely removed. Thereafter, when the pet 1 smoothly defecates through the potty training device 100 in which the defecation inducers 2 are not received, the potty training device 100 are finally removed from the toilet to check if the pet 1 is able to defecate through the toilet without the potty training device 100.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A potty training device comprising:
a support member providing a support surface for supporting a pet, wherein at least a portion of the support surface is configured to receive defecation inducers; and
an interfering member disposed on the support member to hinder the pet from defecating in the defecation inducers,
wherein the support member comprises:
a support plate providing the support surface; and
a discharge hole formed through the support plate so that the pet's excrement is discharged through the discharge hole, and
wherein the interfering member is provided in a cover, wall, or grate shape and positioned above the defecation inducers to allow the pet to access the defecation inducer by smell, touch, or sight while making it difficult for the pet to defecate into the defecation inducer.

2. The potty training device of claim 1, wherein the support member further comprises a container attached to the support surface or a containment boundary portion projecting from the support surface to provide a containment space on the support surface in which the defecation inducers are received.

3. The potty training device of claim 1, wherein the interfering member is disposed toward the pet on the support member so that an end thereof is positioned above the defecation inducers.

4. A potty training device comprising:
a support member providing a support surface for supporting a pet, wherein at least a portion of the support surface is configured to receive defecation inducers; and
an interfering member disposed on the support member to hinder the pet from defecating in the defecation inducers, and disposed toward the pet on the support member so that an end thereof is positioned above the defecation inducers,
wherein the support member comprises:
a support plate providing the support surface;
a discharge hole formed through the support surface so that excrement of the pet is discharged through the discharge hole; and
a guide rod extending from one end of the discharge hole toward the other end, and
wherein an upper surface of the guide rod is configured to receive the defecation inducers.
